(19) United States
(12) Patent Application Publication
(10) Pub. No.: US 2014/0125611 A1
(43) Pub. Date: May 8, 2014

(54) APPARATUS AND METHOD FOR DISPLAYING ZOOMED DATA IN TERMINAL

(71) Applicant: Samsung Electronics Co., Ltd., Gyeonggi-do (KR)

(72) Inventor: Cheong-Jae LEE, Daegu (KR)

(73) Assignee: Samsung Electronics Co., Ltd., Gyeonggi-do (KR)

(21) Appl. No.: 14/068,490

(22) Filed: Oct. 31, 2013

(30) Foreign Application Priority Data
Nov. 2, 2012 (KR) 10-2012-0123606

(51) Int. Cl. G09G 5/00; G06F 3/0484

(52) U.S. Cl. CPC G09G 5/006; G06F 3/04842
USPC 345/173

(57) ABSTRACT

An apparatus for displaying zoomed data in a terminal includes a display including a display area for displaying zoomed data in a zoom mode, and a border surrounding the display area and used to select some of original data as zoomed data to be displayed in the display area; and a controller for, if an arbitrary point is selected in the border, detecting a point of the original data, which corresponds to the selected arbitrary point of the border, and displaying some of the original data in the display area as zoomed data on a basis of the detected point of the original data.

### CLAIM OF PRIORITY

This application claims the benefit under 35 U.S.C. §119(a) of a Korean Patent Application filed in the Korean Intellectual Property Office on Nov. 2, 2012 and assigned Serial No. 10-2012-0123606, the entire disclosure of which is incorporated herein by reference.

### BACKGROUND

1. Technical Field

The present disclosure relates generally to an apparatus and method for displaying zoomed data in a terminal, and more particularly, to an apparatus and method capable of quickly displaying desired zoomed data during a zoom mode in a terminal.

2. Description of the Related Art

Terminals have a display function of zooming in (or enlarging) a particular content or data and displaying the zoomed data.

In a zoom mode, if a zoom ratio is set by a user, only some of the original data is zoomed in for display at the set zoom ratio, and then displayed zoomed data may be shifted to a desired location through manipulating input arrow keys or moving gestures such as scrolls or touch inputs.

However, in order to display some data located on the top area while some data located in the middle or bottom area of the original data are enlarged, the user needs to inconveniently manipulate the screen or arrow keys to display the top area content.

### SUMMARY

An aspect of exemplary embodiments of the present invention is to provide an apparatus and method capable of quickly providing desired zoomed data in a zoom mode.

Another aspect of exemplary embodiments of the present invention is to provide an apparatus and method capable of quickly displaying zoomed data located in an edge area of the original data in a zoom mode.

In accordance with one aspect of the present invention, an apparatus for displaying zoomed data in a terminal includes: a display screen for displaying original data and a border on the display screen during a zoom mode, and displaying the original data within the border as the zoomed data on the entire display screen; and a controller for, if a particular point is selected in a border line of the display screen, detecting a point of the original data that proportionally corresponds to the selected point along the border line, and displaying some of the original data from the detected point on the display screen.

In accordance with another aspect of the present invention, a method for displaying zoomed data in a terminal of the type having a display screen including a display area and a border within the display area includes: displaying some of original data in the display area as zoomed data in a zoom mode; and if a specific point of the border is selected while displaying the zoomed data in the display area, detecting a point of the original data that proportionally corresponds to the selected point border, and displaying some of the original data around the detected point in the display area.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a structure of a terminal according to an embodiment of the present invention;

FIG. 2 is a flowchart illustrating a process of displaying zoomed data in a terminal according to an embodiment of the present invention;

FIG. 3 are a diagram illustrating the operative process of FIG. 2;

FIGS. 4A and 4B are diagrams illustrating the operative the process of FIG. 2; and

FIGS. 5A and 5B are diagrams illustrating the operative the process of FIG. 2. Throughout the drawings, the same drawing reference numerals will be understood to refer to the same elements, features and structures.

### DETAILED DESCRIPTION

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. For the purposes of simplicity, descriptions of well-known functions and constructions are omitted for clarity and conciseness.

Terminals, to which embodiments of the present invention are applicable, may include mobile terminals and fixed terminals. The mobile terminals, easy-to-carry mobile electronic devices, may include video phones, mobile phones, smart phones, International Mobile Telecommunication 2000 (IMT-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, e-Book readers, portable computers (laptop computers, tablet computers, and the like), digital cameras, or the like. The fixed terminals may be desktop Personal Computers (PCs).

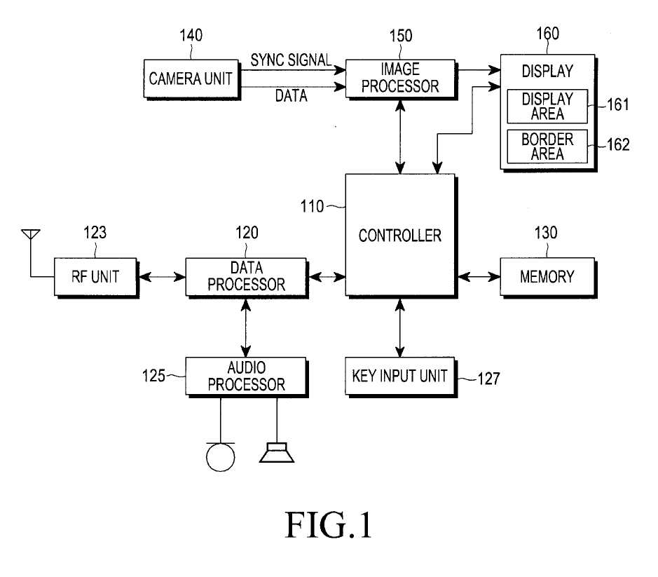

FIG. 1 illustrates a structure of a terminal according to an embodiment of the present invention.

Referring to FIG. 1, a Radio Frequency (RF) unit 123 includes an RF transmitter for up-converting a frequency of transmission signals and amplifying the up-converted transmission signals, and an RF receiver for low-noise-amplifying received signals and down-converting a frequency of the amplified received signals. A data processor 120 includes a transmitter for coding and modulating the transmission signals, and a receiver for demodulating and decoding the received signals. Specifically, the data processor 120 may include a modulator/demodulator (modem) and a coder/decoder (codec). The codec includes a data codec for processing data signals such as packet data, and an audio codec for processing audio signals such as voice data. An audio processor 125 plays received audio signals output from the audio codec in the data processor 120 using a speaker SPK, and transfers audio signals detected by a microphone MIC to the audio codec in the data processor 120.

A key input unit 127 includes alphanumeric keys for inputting numeric and character information, and function keys for setting various functions.

A memory 130 may include a program memory and a data memory. The program memory may store control programs for controlling the overall operation of the terminal. In accordance with an embodiment of the present invention, the program memory may store control programs for displaying zoomed data located along an edge line of the display unit of earlier shown original data when a particular border line point is selected by a user during a zoom mode. Here, the position of the selected border line matches the approximate location of the edge line of the original data screen so that users can intuitively retrieve the zoomed data of their choice. The data memory may temporarily store the data generated during execution of the programs.

A controller 110 controls the overall operation of the terminal.

If a specific point is selected by the user along a border line 162 of a display 160 during a zoom mode, the controller 110 detects a point of the original data, which proportionally corresponds to the selected point of the selected border line, and then displays some of the original data located around the edge point that closely matches the selected point along the border line in a display area 161 as zoomed data. Hence, the border line 162 proportionally corresponds to the edge line of the original data. Therefore, if a particular point is selected along the border line 162, the controller 110 detects a point corresponding to the selected point of the border line 162 along the edge line for displaying the original data thereon.

More particularly, if a specific point is touched along the border line 162 while another location within the display area 161 is being touched, this event triggers the controller 110 to detect a point or location of the original data that proportionally corresponds to the touched point of the border line 162 for display. Thus, if an arbitrary point of the border line 162 is selected, the controller 110 shifts a screen view to the original data that proportionally corresponds to the selected point along the border line 162.

Upon switching to the zoom mode, the controller 110 activates the screen view that provides some of the original data to the display area 161 as zoomed data.

The screen view varies in size at a zoom ratio set in the zoom mode, and is shifted to a point selected by the user in the original data, and some of the original data, in which the shifted screen view is located, is provided to the display area 161 as zoomed data.

If an arbitrary point of the border area 162 is selected while the screen view is activated, the controller 110 shifts the screen view to a point of the original data, which corresponds to the selected arbitrary point of the border area 162, and provides some of the original data, in which the shifted screen view is located, as zoomed data for the display area 161.

If an arbitrary point is selected in the border area 162, the controller 110 shifts the screen view to a point corresponding to the selected arbitrary point of the border area 162 in the edge area of the original data, and provides some of the original data, in which the shifted screen view is located, as zoomed data for the display area 161.

If the screen view is shifted to a point corresponding to the selected arbitrary point of the border area 162 in the edge area of the original data, a point ‘c’ of an edge area of the screen view, which corresponds to the selected arbitrary point ‘a’ of the border area 162, is located at a point ‘b’ corresponding to the selected arbitrary point ‘a’ of the border area 162 in the edge area of the original data.

If a moving gesture such as a scroll and a touch occurs in the display area 161, the controller 110 shifts the screen view to correspond to the direction of the moving gesture, and provides some of the original data, in which the shifted screen view is located, as zoomed data for the display area 161.

A camera unit 140 includes a camera sensor for capturing image data and converting the captured optical image signals into electrical image signals, and a signal processor for converting the analog image signals captured by the camera sensor into digital image data. The camera sensor is assumed to be a Charge-Coupled Device (CCD) or Complementary Metal-Oxide Semiconductor (CMOS) sensor, and the signal processor may be implemented with a Digital Signal Processor (DSP). The camera sensor and the signal processor may be implemented either integrally or separately.

An image processor 150 performs Image Signal Processing (ISP) to display the image signals output from the camera unit 140 on the display 160. The ISP may include functions such as gamma correction, interpolation, spatial conversion, image effecting, image scaling, Auto White Balance (AWB), Auto Exposure (AE), Auto Focus (AF), and the like. The image processor 150 processes the image signals output from the camera unit 140 on a frame basis, and outputs the frame image data depending on the characteristics and size of the display 160. The image processor 150, which includes a video codec, may compress the frame image data displayed on the display 160 using a set video coding scheme, and decompress the compressed frame image data into its original frame image data using a video decoding scheme. The video codec may be a Joint Photographic Expert Group (JPEG) codec, a Moving Picture Expert Group 4 (MPEG4) codec, a Wavelet codec, or the like. The image processor 150 is assumed to include an On Screen Display (OSD) function, and may output OSD data depending on the size of the displayed screen, under control of the controller 110.

The display 160 displays, on its screen, the image signals output from the image processor 150 and the user data output from the controller 110. The display 160 may be implemented with Liquid Crystal Display (LCD). In this case, the display 160 may include an LCD controller, a video memory capable of storing image data, and an LCD panel. If the LCD is implemented in a touch screen manner, the display 160 may serve as an input unit.

If the display 160 is implemented with a touch screen unit, the touch screen unit has a Touch Screen Panel (TSP) including a plurality of sensor panels, which may include a capacitive sensor panel capable of recognizing a fingertip touch, and an electromagnetic induction sensor panel capable of sensing a fine touch by a touch pen like a stylus pen.

The display 160 includes the display area 161 for displaying data, and the border line 162 that surrounds the display area 161 and may be used to select some of the original data as zoomed data to be displayed in the display area 161 in the zoom mode.

The border line 162 defines an area used to directly provide some data located at the outer edge of the original data as zoomed data in the display area 161 Therefore, the border line 162 proportionally corresponds to an edge area of the original data, so that a user can select a particular point along the border line 162 to retrieve and display a portion of original data placed along the edge of original data displayed prior to the zooming mode.

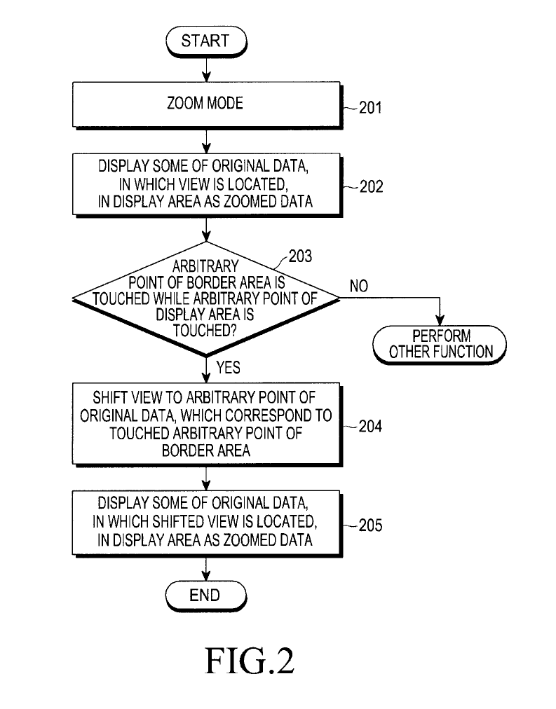

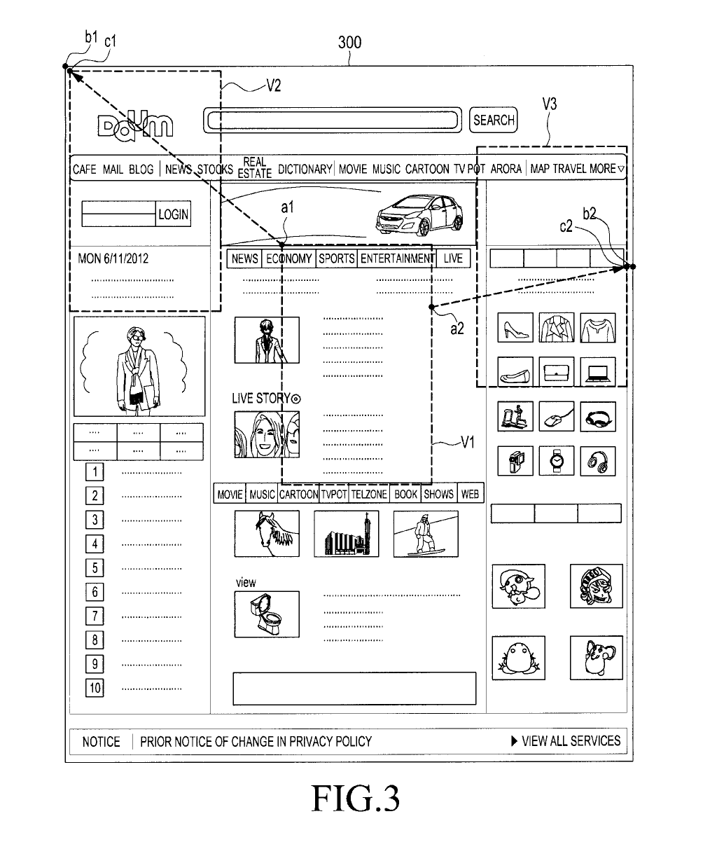

Hereinafter, an operation of displaying zoomed data in the above-described terminal will be described in detail with reference to FIGS. 2 to 5B. In particular, FIG. 2 is a flowchart illustrating a process of displaying zoomed data in a terminal according to an embodiment of the present invention, and FIGS. 3, 4A, 4B, 5A and 5B are diagrams for a description of the process of FIG. 2.

Referring to FIG. 2, if data to be displayed is selected on the terminal, the controller 110 displays the selected original data in the display area 161 of the display 160. If a zoom view is selected by the user, the controller 110 switches to the zoom mode in step 201. The zoom view selected by the user can be a soft button or hard button.

After switching to the zoom mode, the controller 110 activates a screen viewer, defined by a dotted line box, for providing some of the original data to the display area 161 as zoomed data, and provides some of the original data within the screen viewer in the display area 161 in enlarged format, in step 202.

As the controller 110 is switched to the zoom mode, the screen viewer, defined by a dotted box, is located at the center of the original data. Here, the size of screen viewer can be varied, thus the board has a size corresponding to a zoom ratio set by the user.

The controller 110 determines in step 203 whether a particular point is touched within the display area 161 displaying the zoomed data while a specific point of the border line 162 is touched. If so, the controller 110 shifts the screen view to the point of the original image that proportionally correspond to the touched point along the border line 162, in step 204.

Note that the border line 162 corresponds to the outer edge of the display screen.

Therefore, in step 204, the screen view is shifted to a point corresponding to the point selected along the border line 162.

If the screen view is shifted in step 204, the controller 110 provides some of the original data, in which the shifted screen view is located, as zoomed data for the display area 161 in step 205.

Through the operation described in connection with FIG. 2, the terminal may quickly provide the desired zoomed data along the edge area of the original data to the user as the user selects an arbitrary point of the screen viewer, which proportionally corresponds to an edge area of the original data during the zoomed mode.

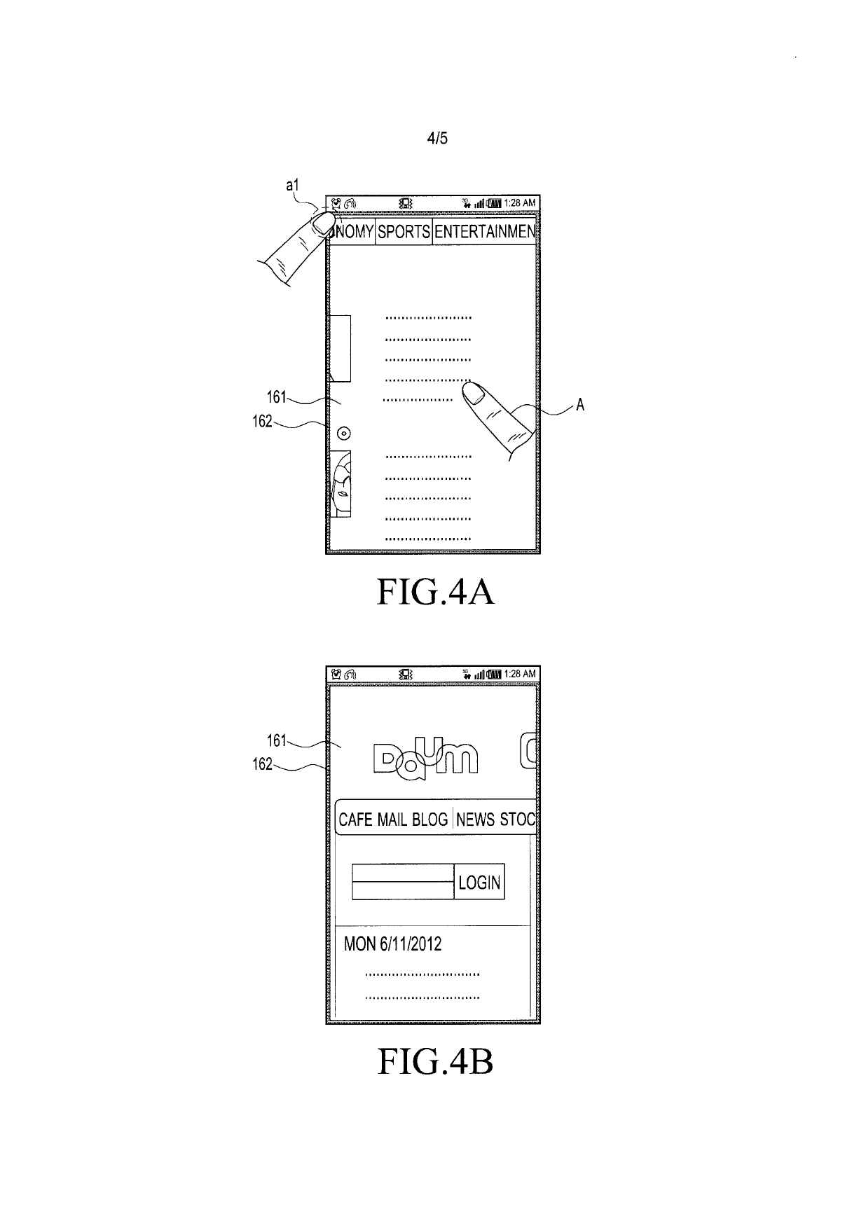

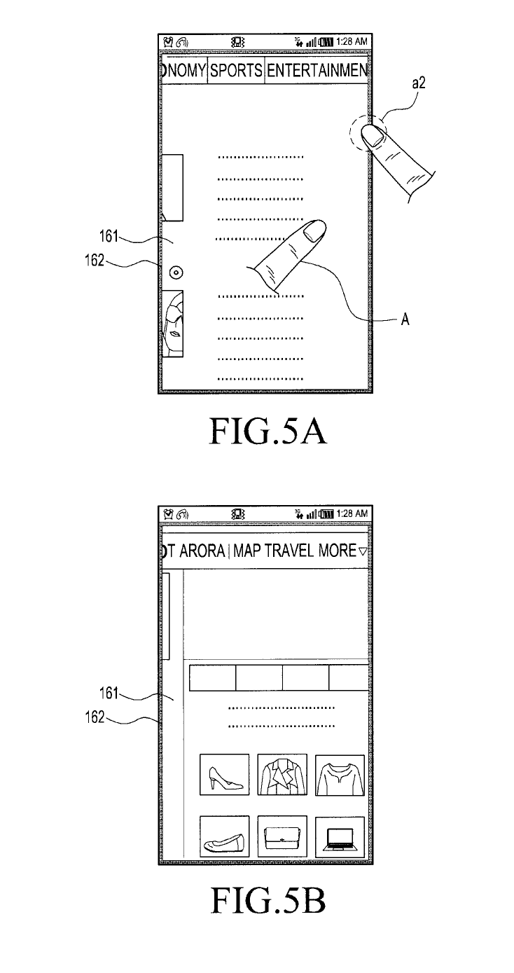

A detailed operation shown in FIG. 2 will be described with reference to FIGS. 3 to 5B, by way of example. Note that the display area 161 in FIG. 3 is substantially same as the display area 161 in FIG. 4 and FIG. 5.

If the zoom mode is selected by the user while original data 300 shown in FIG. 3 is displayed in the display area 161, screen view V1, defined by a dotted box, is activated and placed at a center of the screen where the original data 300 is displayed. Then some of the original data 300 within the screen viewer V1 is enlarged and displayed in the display area 161 as shown in FIG. 4A. A size of the screen viewer V1 varies depending on a preset zoom ratio by a manufacturer or a user.

Thereafter, if an arbitrary point ‘a1’ is touched along the border line 162 of the display screen while an arbitrary point ‘A’ of the display area 161 is touched in FIG. 4A, the controller internally processes, in a previous original data screen, a or screen view V2 to be shifted to a point ‘b1’ corresponding to the touched arbitrary point ‘a1’ along the border line 162 to retrieve data from the upper edge area of the original data 300 in FIG. 3.

As a result, some of original data located around the ‘b1’ or ‘c1 ’ may be displayed as zoomed data as shown in FIG. 4B. Note that the area of screen viewer from V1 to V2 is substantially the same.

Referring to FIG. 5, if the zoom mode is selected by the user while the original data 300 shown in FIG. 3 is displayed in the display area 161, the screen viewer V1, defined by a dotted box, is activated and located at the center of the original data 300. Thus, some of the original data 300 within the screen viewer V1 is displayed in the display area 161 as shown in FIG. 5A. A size of the screen viewer V1 varies depending on a zoom ratio set by the manufacturer or a user.

If an arbitrary point ‘a2’ is touched along the border line 162 while an arbitrary point ‘A’ of the display area 161 is touched in FIG. 5A, the controller internally processes, in a previous original data screen, a screen viewer V3 to be shifted to a point ‘b2’ corresponding to the touched arbitrary point ‘a2’ of the border line 162 along the edge of the original data 300 in FIG. 3.

Due to the shift of the screen viewer V3 as above, some data within the shifted boder V3 is retrieved and displayed as zoomed data as shown in FIG. 5B.

As is apparent from the foregoing description, the proposed zoomed-data displaying apparatus and method may quickly display zoomed data located along an edge area of the original data, such as a corner, left or right side, top or bottom end, in the zoom mode, thus providing user convenience.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for displaying zoomed data in a terminal, comprising:
a display screen including a display area for displaying zoomed data in a zoom mode, and a border line surrounding the display area and used to select some of original data as zoomed data to be displayed in the display area; and
a controller configured for, when a specific point is selected along a border line of the display screen, detecting a point proportionally corresponding to the selected point of border line in the original data, and displaying a portion of the original data adjacent to the detected point on the display screen.

2. The apparatus of claim 1, wherein displaying the portion of the original data adjacent to the detected point is activated by touching a particular point within the zoomed data while contacting the specific point along the border line of the display screen.

3. The apparatus of claim 1, wherein if the specific point is selected along the border line, the controller detects a point proportionally corresponding to the selected point of the border line in an edge line of the original data.

4. The apparatus of claim 1, wherein the portion of the original data adjacent to the detected point is displayed within the border line as the zoomed data.

5. The apparatus of claim 1, wherein if the specific point is touched along the border line while an arbitrary point is touched within the zoomed data, the controller retrieves a portion of the original data from an area proportionally corresponding to the touched point along the border line.

6. The apparatus of claim 1, wherein upon activating the zoom mode, the controller activates a screen view providing some of the original enclosed within the screen viewer as the zoomed data.

7. The apparatus of claim 6, wherein if the specific point is selected along the border line, the controller shifts the screen view to a portion of the original data from an area proportionally corresponding to the selected point along the border line.

8. The apparatus of claim 6, wherein if the specific point is selected along the border line, the screen view is shifted to display the portion of the original data adjacent to a point along an edge line which proportionally corresponds to the selected point along the borderline.

9. The apparatus of claim 6, wherein if a moving gesture detected on the display screen, the controller shifts the screen view to correspond to a direction of the moving gesture for display.

10. The apparatus of claim 6, wherein a size of the screen viewer varies depending on a zoom ratio preset in the zoom mode.

11. A method for displaying zoomed data in a terminal, comprising:
displaying an original data on a display area of a display screen;
displaying a border line on the display area in response to a zoom mode request and displaying a portion of the original data within the border line in the display area as the zoomed data during a zoom mode; and
when a specific point along the border line is selected while displaying the zoomed data in the display area, detecting a point proportionally corresponding to the selected point of the border line in an original data, and displaying a portion of the n original data adjacent to the detected point on the display area.

12. The method of claim 11, wherein the border line proportionally corresponds to an edge line of the original data.

13. The method of claim 11, wherein the detecting comprises, if the specific point is selected along the border line, the controller detects a point proportionally corresponding to the selected point of the border line in an edge line of the original data.

14. The method of claim 11, wherein the portion of the original data adjacent to the detected point is displayed within the border line as the zoomed data.

15. The method of claim 11, wherein if the specific point is touched along the border line while an arbitrary point is touched within the zoomed data, the controller retrieves a portion of the original data from an area proportionally corresponding to the touched point along the border line.

16. The method of claim 11, wherein the displaying comprises:
activating a screen view providing some of the original data enclosed within the screen viewer as the zoomed data in response to an activation of the zoom mode.

17. The method of claim 16, wherein the shifting comprise, if the specific point is selected along the border line, shifting the screen view to a portion of the original data from an area proportionally corresponding to the selected point along the border line.

18. The method of claim 17, wherein if the specific point is selected along the border line, the screen view is shifted to display the portion of the original data adjacent to a point along an edge line which proportionally corresponds to the selected point along the border line.

19. The method of claim 16, further comprising:
shifting, when a moving gesture is detected on the display area, the screen view according to a direction of the moving gesture.

20. The method of claim 16, wherein a size of the screen viewer varies depending on a zoom ratio preset in the zoom mode.
